(19) United States
(12) Patent Application Publication
(10) Pub. No.: US 2023/0004918 A1
(43) Pub. Date: Jan. 5, 2023

(54) AUTOMATIC REMOTE TASK ALLOCATION VIA VIRTUAL TRAINING

(71) Applicant: International Business Machines Corporation, Armonk, NY (US)

(72) Inventors: Fearghal O'Donncha, Aran Islands (IE); Paulito Palmes, Dublin (IE); Albert Akhriev, Mulhuddart (IE)

(21) Appl. No.: 17/363,663

(22) Filed: Jun. 30, 2021

(51) Int. Cl. G06Q 10/06; G06F 16/28

(52) U.S. Cl. CPC G06Q 10/063112; G06F 16/285; G06Q 10/06393

(57) ABSTRACT

A processor may identify a first task of a set of tasks. The processor may identify features of the first task. The processor may generate a reputation assessment for a first user related to the features of the first task. The processor may match the first user to the first task based on the reputation assessment.

### BACKGROUND

The present disclosure relates generally to the field of virtual training, and more specifically to matching users to tasks based on reputation assessments derived from performing virtual training tasks.

Virtual simulations of a task may include simulations of the steps needed to perform the task and the surrounding conditions affecting the performance of the task.

### SUMMARY

Embodiments of the present disclosure include a method, computer program product, and system for matching users to tasks based on reputation assessments derived from virtual tasks.

A processor may identify a first task of a set of tasks. The processor may identify features of the first task. The processor may generate a reputation assessment for a first user related to the features of the first task. The processor may match the first user to the first task based on the reputation assessment.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a system diagram of an exemplary system for matching users to tasks based on reputation assessments, in accordance with aspects of the present disclosure.

FIG. 2 is a flowchart of an exemplary method for matching users to tasks based on reputation assessments, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of virtual training, and more specifically to matching users to tasks based on reputation assessments derived from virtual tasks. While the present disclosure is not necessarily limited to such applications, various aspects of the disclosure may be appreciated through a discussion of various examples using this context.

In some embodiments, a processor may identify a first task of a set of tasks. In some embodiments, the processor may identify features of the first task. In some embodiments, the first task of a set of tasks may relate to a job that is to be completed. In some embodiments, the one or more tasks may be jobs that require particular skills and abilities to be accomplished. In some embodiments, the one or more tasks may be telerobotics tasks that utilize robotics operators who are located remotely to perform the telerobotics tasks. For example, the first task may include operation of a remote-controlled forklift, flight of a drone, or performance of microsurgery. In some embodiments, the set of tasks may be provided to the processor by one or more individuals or entities seeking the performance of the tasks. In some embodiments, information regarding the tasks for which users are sought may be stored in a database of tasks. In some embodiments, the database of tasks may be updated as new tasks are made available for completion.

In some embodiments, the features of the task may relate to the skills, abilities, qualifications, or experience that are needed from a user (or are preferable for the user) for accomplishing the task. For example, it may be desirable for a user operating a remote controlled forklift to have the skills of remote driving and remote maneuvering of machinery, where these skills may be developed through education or experience (e.g., virtual training).

In some embodiments, the individual or entity seeking the performance of the first task may also provide details about the features of the task to the processor. For example, for operation of a remote-controlled forklift, the skills, abilities, qualifications, or experience that is needed may include 100 hours of performing remote robotic tasks, 10 hours of performing robotic tasks requiring maneuvering in crowded spaces, and completion of three safety and driving courses. In some embodiments, the features of the task may be determined by an artificial intelligence (“AI”) model. In some embodiments, the AI model may be based on recommender system algorithms that match individuals to tasks based on descriptive features of the individual (user or individual features) and task (task features). Examples of descriptive features of the individual may include educational qualifications and certification, previous tasks completed, or performance on assigned virtual or robotic tasks. Examples of descriptive features of the task may include required qualifications, desired qualifications, and time constraints. A variety of AI models may be used to process these data or features and match users to tasks. Examples of the AI model may include singular value decomposition (SVD) or Restricted Boltzmann Machines (RBM). In some embodiments, the AI model may be a classification AI model. In some embodiments, the AI model may classify tasks into groups of tasks requiring certain skills, abilities, qualifications, or experience (e.g., specific courses or degrees, number of hours performing generic or specific tasks, etc.).

In some embodiments, the processor may generate a reputation assessment for a first user related to the features of the first task. In some embodiments, the reputation assessment may relate to qualifications or credentials of the first user that relate to the first task. In some embodiments, the qualifications or credentials of the first user may include educational attainments, completed coursework (e.g., a course on forklift operation), degrees obtained, certificates obtained (e.g., a certificate on factory safety procedures), amount of training/schooling (e.g., 10 hour course on driving remote vehicles), etc.

In some embodiments, the reputation assessment may relate to experiences of the first user that relate to features of the task (e.g., skills, abilities, qualifications, or experience desired of a user to perform the task). For example, the first user may have worked as a remote driver at a prior job and logged 100 hours of remote driving time. The user's experience may indicate that the user has the skills and ability to move a remote vehicle from one location to another. In some embodiments, the experiences of the first user that relate to features of the task may be obtained from performance of a virtual equivalent of the first task. For example, the first user may not have operated a robotic forklift and may have only taken a course on forklift operation. The first user may gain experience operating a remote, robotic forklift in a virtual simulation of remote, robotic forklift operation.

In some embodiments, the processor may generate a reputation assessment for a first user related to the features of the first task by aggregating quantifiable information about the experiences, credentials, and qualifications of the first user. In some embodiments, the experiences, credentials, and qualifications of the first user may reflect the skills and abilities of the first user to perform the first task. In some embodiments, generating the reputation assessment may involve receiving a generic profile for the user that identifies the user. Any information regarding the credentials, qualifications, or experiences of the user may be quantified (e.g., tabulated, rated, or scored in some manner) and combined into an overall assessment related to the first task.

In some embodiments, the reputation assessment (e.g., the reputation assessment related to the features of the first task) may be associated with a category of tasks having common features as the first task. In some embodiments, reputation assessment may be associated with performance of one or more skills required for completing the first task.

In some embodiments, the processor may match the first user to the first task based on the reputation assessment. Matching of users and tasks may be conducted by several exemplary methods. In one approach, information regarding the reputation score of the user may be used alongside contextual information (previous tasks completed, additional qualifications or certifications) to match a user to a given task. A variety of sequence prediction algorithms may be used, including Recurrent Neural Networks (RNN) or Long Short-Term Memory (LSTM). In some embodiments, the similarity of the task to other tasks previously completed by the user may be used to guide matching. In some embodiments, an item-item similarity matrix may be used to identify tasks that are similar, and the task is then matched to a user who has completed these similar tasks in the past. In some embodiments, the matching may involve comparing the reputation assessment score of the first user to a score threshold. In some embodiments, if the score is greater than the score the threshold, the first user may be matched to the first task. In some embodiments, the reputational assessment of the first user may be compared to the reputational assessment of other users participating in the disclosed process. In some embodiments, the first user may be matched to the first task because he has a reputational assessment that exceeds the reputational assessment (e.g., a score) of one or more other users.

In some embodiments, the processor may match the first user to the first task based on a task priority factor. In some embodiments, the task priority factor may relate to a heightened urgency for matching a user to the task based on a recommendation provided by the individual or entity that sought the completion of the task. In some embodiments, the heightened urgency may increase the likelihood that the first user is matched to the first task. In some embodiments, the task priority factor may relate to a reputation score for the individual or entity that sought the completion of the task. In some embodiments, the reputation score may be associated with an assessment of the preferability for a user to complete tasks listed by the individual or entity that sought the completion of the task. In some embodiments, the reputation score may be obtained from feedback by users who performed tasks made available for completion by the individual or entity that sought the completion of the first task. In some embodiments, a higher reputation score may increase the likelihood that the first user is matched to the first task.

In some embodiments, the task priority factor may relate to a volume or quantity of tasks in a database of tasks for which users are sought. In some embodiments, a higher volume or quantity of first tasks in the database of tasks may increase the likelihood that the first user is matched to the first task. In some embodiments, a higher volume or quantity of tasks other than the first task in the database of tasks may decrease the likelihood that the first user is matched to the first task. In some embodiments, a higher volume or quantity of first tasks in the database may result in the user being offered virtual tasks that are similar to the task in the database. This may be used to dynamically provide users with pertinent skills to perform tasks that have higher volume or quantity of tasks in the database.

In some embodiments, the processor may evaluate a performance of the first task by the first user. In some embodiments, the processor may update the reputation assessment for the first user based on the performance of the first task. In some embodiments, the processor may monitor the progress and completion of the first task by the first user. In some embodiments, the processor may compare the outcome of the task performed by the first user with an expected outcome. In some embodiments, the processor may update the reputation assessment for the first user based on the performance (e.g., comparison of the outcome by the first user to an expected outcome).

In some embodiments, the performance of the first task may be evaluated based on criteria that can be objectively evaluated. In some embodiments, the performance of the first task may be evaluated using a scoring system that results in a numerical score/evaluation for the performance. In some embodiments, the outcome of the first task may have multiple attributes (e.g., characteristics or components that make up the best outcome). In some embodiments, the performance of the first user regarding each attribute may be scored (e.g., compared to an ideal outcome) with a numerical score. In some embodiments, the numerical score for each attribute may be summed to arrive at a final score that is compared to a threshold score.

In some embodiments, the processor may update the reputation assessment of the first user based on the evaluation of the performance of the first task. In some embodiments, the processor may update the reputation assessment to include that a task was performed successfully (e.g., a tabulation of number of times the task was performed or a log of the number of hours a task was performed may be updated). In some embodiments, the processor may update the reputation assessment to include information regarding the performance score achieved.

In some embodiments, the processor may generate the reputation assessment related to the features of the first task by evaluating a performance by the first user of a virtual task associated with the first task. In some embodiments, the reputation assessment for the first task may be based on the first user performing a virtual task associated with the first task. In some embodiments, the virtual task may be a task performed in a virtual environment that replicated/simulates the performance of a task (e.g., a task associated with the first task), the environment in which the task is to be performed, the parameters/constraints/conditions for performance of the task, etc. In some embodiments, the simulation may include one or more training sequences.

For example, virtual forklift operation may involve training sequences including: driving the forklift from its parked location through the factory floor around other factory workers and objects; maneuvered the forklift through rows of goods to arrive at the goods that are to be lifted by the forklift; properly positioning the forklift to lift some goods while not disturbing others; rotating the forklift without disturbing the goods on the forklift, other goods that have not been lifted, and good that are stocked on shelves surrounding the forklift; releasing the goods from the forklift, etc. In some embodiments, the training sequences may relate to one or more features of the first task. For example, the training sequences may relate to the skills/abilities of: remote driving, maneuvering machinery, operating a forklift, driving through a setting with many obstacles and people, maneuvering machinery in a crowded environment, etc.

In some embodiments, the one or more training sequences may be provided to the first user, and a performance score may be assigned to the first user based on completion of the one or more training sequences. In some embodiments, the performance score may be used to generate the reputation assessment for the first user.

In some embodiments, the first user may be able to increase or improve a reputation assessment related to the first task by completing the virtual task. In some embodiments, the performance of the virtual task may be evaluated based on criteria that can be objectively evaluated. In some embodiments, the performance of the virtual task may be evaluated using a scoring system that results in a numerical score/evaluation for the performance. In some embodiments, the outcome of the virtual task may have multiple attributes (e.g., characteristics or components that make up the best outcome). In some embodiments, the performance of the first user regarding each attribute may be scored (e.g., compared to an ideal outcome) with a numerical score. In some embodiments, the numerical score for each attribute may be summed to arrive at a final score that is compared to a threshold score.

In some embodiments, the reputation assessment (e.g., related to the features for the first task) may be improved or increased by completing the virtual task successfully. In some embodiments, successful completion of the virtual task may include: obtaining an outcome that is identical to an expected outcome, obtaining an outcome that deviates from the expected outcome by an amount that is within an acceptable range, obtaining a score for performance of the virtual equivalent task that exceeds a threshold, etc. In some embodiments, the processor may update the reputation assessment of the first user based on the evaluation of the performance of the virtual task. In some embodiments, the processor may update the reputation assessment to include that a virtual task was performed (e.g., a tabulation of number of times the task was performed or a log of the number of hours a task was performed may be updated). In some embodiments, the processor may update the reputation assessment to factor in the performance score achieved.

In some embodiments, the virtual task associated with the first task may be a simulation of the same task as the first task (e.g., virtual robotic forklift operations when the first task is robotic forklift operation), a simulation of tasks in the same category as the first task (e.g., virtual remote machinery operation), or a simulation of tasks requiring similar skills/abilities (e.g., virtual and remote tasks involving driving, virtual and robotic tasks involving maneuvering, virtual and robotic tasks involving working under pressure, etc.). In some embodiments, the simulation of the virtual task associated with the first task may be obtained from a database storing simulated virtual tasks. In some embodiments, the simulation of the virtual task associated with the first task may be created by the processor if there are no simulations of the virtual task related to the first task available in the database (e.g., there are no simulations of the first task, tasks in the same category as the first task, or other tasks requiring similar skills or abilities as the first task in the database).

In some embodiments, the processor may provide the first user with a list of suggested virtual tasks to perform. In some embodiments, the list of suggested virtual tasks may include suggestions for virtual tasks for the first user to perform. In some embodiments, the virtual tasks may be suggested to the first user based on first user specified objectives such as desired tasks or desired compensation. For example, the user may specify (e.g., when registering with the system for matching users to tasks) that she would like to perform tasks (non-virtual) that are compensated at a certain rate. The processor may identify that the tasks that are compensated at the specified rate require certain skills that the user does not have or skills for which the user has a lower reputation assessment than the system for matching users to tasks is currently accepting (e.g., given the various factors that affect a user's selection for a task on the marketplace). The training queue (e.g., the list of suggested virtual tasks) for the first user may be updated to include virtual tasks that are associated with those skills (e.g., virtualizations of tasks related to those features).

In some embodiments, the first user may specify that she would like to perform certain desired tasks (e.g., robotic forklift operation), and the virtual tasks suggested for her may be identical or equivalent tasks (virtual robotic forklift operations), tasks that are lumped in a category (virtual robotic machinery operation), or tasks that lead to the development of skills or abilities (e.g., features) related to the desired tasks (e.g., virtual, remote tasks involving driving, virtual, robotic tasks involving maneuvering, virtual, robotic tasks involving working well under pressure, etc.). In some embodiments, the processor may update the list of suggested virtual tasks to perform based on the performance of the virtual task related to the first task by the first user.

In some embodiments, the virtual tasks may be suggested to the user based on qualifications, skills, or credentials of the user. For example, when registering with the system for matching users to tasks a user may create a profile that includes information about the user's skills, qualifications, credentials, and experiences (e.g., based on which the user's reputation assessment is made for a task). In some embodiments, the suggested virtual tasks may include tasks that require the same or similar skills as the user has (based on the user's profile), tasks that fall under the same category as other tasks that the user has experience with, or virtual tasks that are equivalent of or identical to tasks with which the user already has experience (e.g., to increase the user's reputation assessment by increasing the amount or quality of the user's experience with that task).

In some embodiments, the list of suggested virtual tasks to perform may be updated based on one or more tasks available in a database of tasks for which users are sought. In some embodiments, the virtual tasks suggested to the user may be based on (or updated based on) the features related to (e.g., skills or abilities needed by) tasks that have not already been assigned or completed by another user. In some embodiments, these tasks may be newly added by the individuals or entities seeking the performance of the task. In some embodiments, these tasks may be tasks which were not previously matched to a user or tasks which previously matched users did not complete. In some embodiments, the list of suggested virtual tasks may be updated to include tasks available in the database which have features that relate to the skills, abilities, or experience of the first user. For example, the first user may already have 90% of the skills/abilities/experiences relating to the features of a task. The first user may perform a virtual task (e.g., suggested on the updated list) to increase her experience so that she can have 100% of the skills/abilities/experiences relating to the features of a task (and be matched to the task).

In some embodiments, the processor may determine a compensation for the performance of the first task. In some embodiments, the processor may determine the compensation based on the urgency or priority of completing the task. In some embodiments, the urgency or priority may be specified by those seeking performance of the task. In some embodiments, the way that the compensation should reflect the urgency or priority (e.g., bonus payment rate) may be determined by those seeking performance of the task. In some embodiments, the way that the compensation should reflect the urgency or priority may be determined by an artificial intelligence model. For example, the model may assess the number of users seeking to perform tasks, the number of tasks available to be performed (e.g., number of tasks for which users are being sought/matched), the reputation assessment related to the first task of the users seeking to perform tasks, the features of the first task (e.g., skill, ability, qualifications or experience expertise required for the performance of the task), information in the profile of users related to desired compensation, etc. to determine an appropriate compensation. In some embodiments, the compensation may be based on the complexity of the first task, the number of times the first task is to be performed, the speed during at which the first task is to be performed, or other conditions that affect the ease of performing the first task, etc. In some embodiments, the individual or entity seeking the performance of the first task may provide details about these factors and/or the compensation (e.g., a compensation rate) to be provided for the completion of the first task.

In some embodiments, the processor may identify tasks in the database of tasks that have not been matched to users. In some embodiments, the processor may identify features of the tasks that have not been matched. In some embodiments, based on the identification of features, additional training materials may be developed related to those features. In some embodiments, the training materials may be simulations of tasks that are associated with those features. In some embodiments, the processor may make a recommendation or provide feedback for the development of educational materials such as certificates or courses.

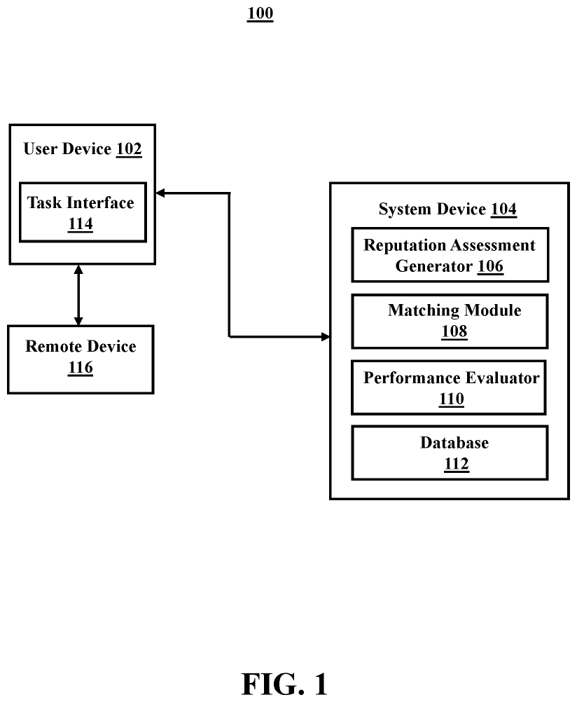

Referring now to FIG. 1, a block diagram of a system 100 for matching users to tasks based on reputation assessments is illustrated. System 100 includes user device 102, system device 104, and remote device 116. The system device 104 is configured to be in communication with user device 102, and user device 102 is configured to be in communication with remote device 116. The system device 104 includes reputation assessment generator 106, matching module 108, performance evaluator 110, and database 112. The database 112 stores data regarding the first set of tasks, features of the tasks included in the set of tasks, information regarding individuals or entities seeking the performance of tasks, information regarding users, and information associated with the reputation assessment of a user (e.g., information relating to the reputation assessment of each user related to features of each task). In some embodiments, the user device 102 and system device 104 may be any devices that contain a processor configured to perform one or more of the functions or steps described in this disclosure.

The system device 104 identifies a first tasks of the set of tasks and identifies features of the first task. The features relate to the skills, abilities, qualifications, or experience desired for a user who is sought to perform the first task. The reputation assessment generator 106 generates a reputation assessment for the first user related to the features of the first task.

In some embodiments, the reputation assessment generator 106 may evaluate a performance by the first user of a virtual task associated with the first task. In some embodiments, the first user may perform the virtual task using a task interface 114 on user device 102. In some embodiments, the virtual task may be a simulation of a series of training sequences that mirror the steps to be performed when performing the first task. The performance evaluator 110 may evaluate the performance of the virtual task and provide a performance score to the reputation assessment generator 106. The performance score may be included among other skills, abilities, qualifications, or experience of the first user to generate the reputation assessment of the first user related to first task (e.g., the features of the first task).

The matching module 108 may then use the reputation assessment for the first user related to the features of the first task to match the first user to the first task. In some embodiments, the matching module 108 may also use a priority factor to match the first task to the first user.

In some embodiments, the user may use the task interface 114 on user device 102 to perform the first task remotely (e.g., remotely operate machinery [remote device 116] located in a remote location). In some embodiments, the performance evaluator 110 may evaluate the performance of the first task by the first user. In some embodiments, the reputation assessment generator 106 may update the reputation assessment for the first user based on the performance of the first task.

In some embodiments, the first user may be provided with a list of suggested virtual tasks to perform on task interface 114. In some embodiments, the suggested virtual tasks may be based on the tasks available in database 112. In some embodiments, the list of suggested virtual tasks may be updated based on the performance of the virtual task related to the first task by the first user.

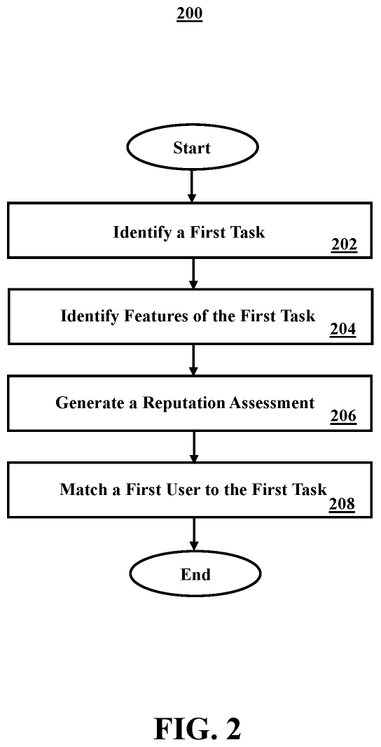

Referring now to FIG. 2, illustrated is a flowchart of an exemplary method 200 for matching users to tasks based on reputation assessments, in accordance with embodiments of the present disclosure. In some embodiments, a processor of a system may perform the operations of the method 200. In some embodiments, method 200 begins at operation 202. At operation 202, the processor identifies a first task of a set of tasks. In some embodiments, method 200 proceeds to operation 204, where the processor identifies features of the first task. In some embodiments, method 200 proceeds to operation 206. At operation 206, the processor generates a reputation assessment for a first user related to the features of the first task. In some embodiments, method 200 proceeds to operation 208. At operation 208, the processor matches the first user to the first task based on the reputation assessment.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

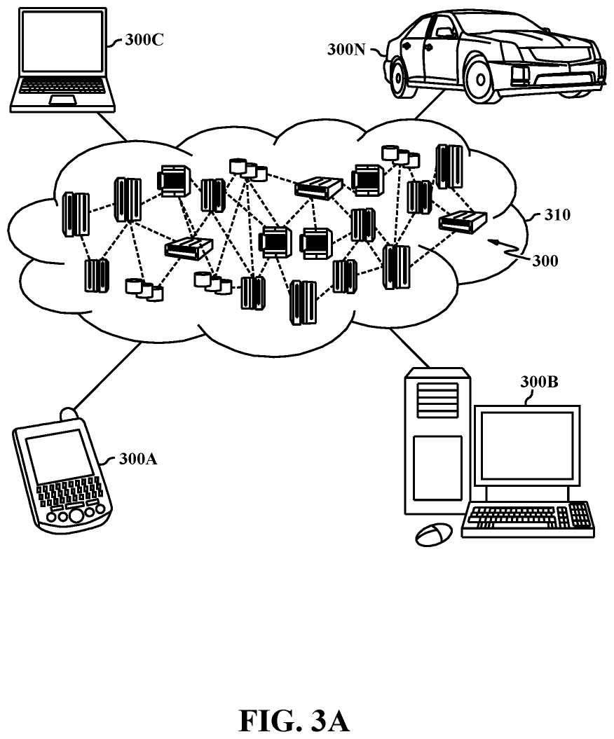

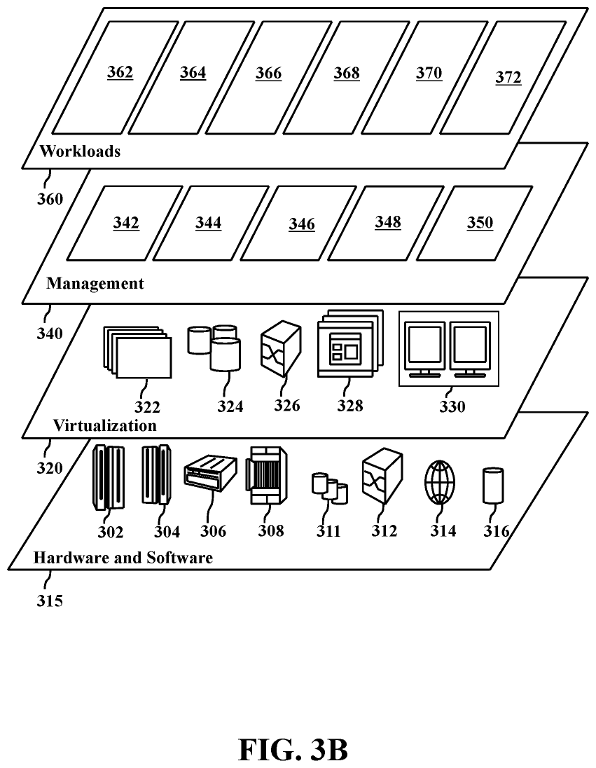

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and matching users to tasks based on reputation assessments derived from performing virtual tasks 372.

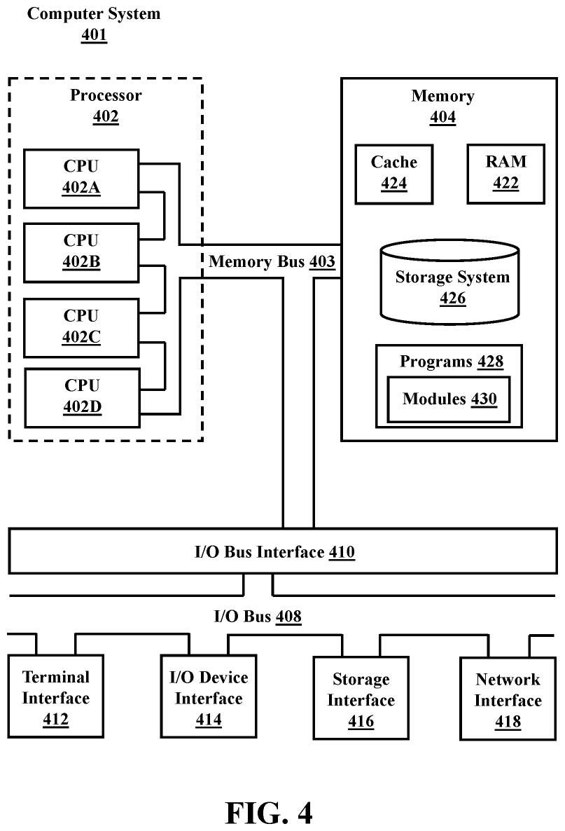

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
identifying, by a processor, a first task of a set of tasks;
identifying features of the first task;
generating a reputation assessment for a first user related to the features of the first task; and
matching the first user to the first task based on the reputation assessment.

2. The method of claim 1, wherein generating the reputation assessment for the first user related to the features of the first task includes evaluating a performance by the first user of a virtual task associated with the first task.

3. The method of claim 1, further comprising:
providing the first user with a list of suggested virtual tasks to perform.

4. The method of claim 3, wherein the list of suggested virtual tasks to perform is updated based on one or more tasks available in a database of tasks for which users are sought.

5. The method of claim 3, further comprising:
updating the list of suggested virtual tasks to perform based on the performance of the virtual task related to the first task by the first user.

6. The method of claim 1, wherein the first user is matched to the first task based on a task priority factor.

7. The method of claim 1, further comprising:
evaluating a performance of the first task by the first user; and
updating the reputation assessment for the first user based on the performance of the first task.

8. A system comprising:
a memory; and
a processor in communication with the memory, the processor being configured to perform operations comprising:
identifying a first task of a set of tasks;
identifying features of the first task;
generating a reputation assessment for a first user related to the features of the first task; and
matching the first user to the first task based on the reputation assessment.

9. The system of claim 8, wherein generating the reputation assessment for the first user related to the features of the first task includes evaluating a performance by the first user of a virtual task associated with the first task.

10. The system of claim 8, the processor being further configured to perform operations comprising:
providing the first user with a list of suggested virtual tasks to perform.

11. The system of claim 10, wherein the list of suggested virtual tasks to perform is updated based on one or more tasks available in a database of tasks for which users are sought.

12. The system of claim 10, the processor being further configured to perform operations comprising:
updating the list of suggested virtual tasks to perform based on the performance of the virtual task related to the first task by the first user.

13. The system of claim 8, wherein the first user is matched to the first task based on a task priority factor.

14. The system of claim 8, the processor being further configured to perform operations comprising:
evaluating a performance of the first task by the first user; and
updating the reputation assessment for the first user based on the performance of the first task.

15. A computer program product comprising a computer readable storage medium having program instructions embodied therewith, the program instructions executable by a processor to cause the processor to perform operations, the operations comprising:
identifying a first task of a set of tasks;
identifying features of the first task;
generating a reputation assessment for a first user related to the features of the first task; and
matching the first user to the first task based on the reputation assessment.

16. The computer program product of claim 15, wherein generating the reputation assessment for the first user related to the features of the first task includes evaluating a performance by the first user of a virtual task associated with the first task.

17. The computer program product of claim 15, the processor being further configured to perform operations comprising:
providing the first user with a list of suggested virtual tasks to perform.

18. The computer program product of claim 17, wherein the list of suggested virtual tasks to perform is updated based on one or more tasks available in a database of tasks for which users are sought.

19. The computer program product of claim 17, the processor being further configured to perform operations comprising:
updating the list of suggested virtual tasks to perform based on the performance of the virtual task related to the first task by the first user.

20. The computer program product of claim 15, the processor being further configured to perform operations comprising:
evaluating a performance of the first task by the first user; and
updating the reputation assessment for the first user based on the performance of the first task.
